(19) United States
(12) Patent Application Publication
(10) Pub. No.: US 2013/0278464 A1
(43) Pub. Date: Oct. 24, 2013

(54) METHOD AND APPARATUS FOR DIRECTIONAL PROXMITY DETECTION

(71) Applicants: Fan Xia, Shanghai (CN); Justin Lipman, Shanghai (CN)

(72) Inventors: Fan Xia, Shanghai (CN); Justin Lipman, Shanghai (CN)

(21) Appl. No.: 13/976,688

(22) PCT Filed: Sep. 30, 2011
(86) PCT No.: PCT/US11/54326

§ 371 Date: Jun. 27, 2013

(51) Int. Cl. H01Q 3/36

(52) U.S. Cl. CPC H01Q 3/36
USPC 342/430

(57) ABSTRACT

A method and apparatus to facilitate directional proximity detection by a wireless device. In one embodiment of the invention, the wireless device has a phased array antenna system that facilitates the directional detection of other wireless device(s). For example, in one embodiment of the invention, the phased array antenna system of the wireless device uses a radiation pattern beam that circumrotates the wireless device to detect the proximity and location of other wireless devices. In another example, in one embodiment of the invention, the wireless device uses a search strategy to optimize the process to detect the proximity and location of other wireless devices. The search strategy may adjust the radiation pattern beam to any desired angle to detect the proximity and location of other wireless devices.

### FIELD OF THE INVENTION

This invention relates to a wireless device, and more specifically but not exclusively, to a method and apparatus to facilitate directional proximity detection by the wireless device.

### BACKGROUND DESCRIPTION

In a wireless network, the mobile stations are able to communicate with each other using a wireless communication protocol. However, each mobile station does not have the capability to detect the location and proximity of another mobile station.

### BRIEF DESCRIPTION OF THE DRAWINGS

The features and advantages of embodiments of the invention will become apparent from the following detailed description of the subject matter in which:

FIG. 1 illustrates an elementary antenna array in accordance with one embodiment of the invention;

FIG. 2 illustrates a linear phase antenna array in accordance with one embodiment of the invention;

FIG. 3 illustrates the direction of the beam of the antenna array in accordance with one embodiment of the invention;

FIG. 4 illustrates a usage scenario in accordance with one embodiment of the invention; and

FIG. 5 illustrates a system to implement the methods disclosed herein in accordance with one embodiment of the invention.

### DETAILED DESCRIPTION

Embodiments of the invention described herein are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference numerals have been repeated among the figures to indicate corresponding or analogous elements. Reference in the specification to “one embodiment” or “an embodiment” of the invention means that a particular feature, structure, or characteristic described in connection with the embodiment is included in at least one embodiment of the invention. Thus, the appearances of the phrase “in one embodiment” in various places throughout the specification are not necessarily all referring to the same embodiment.

Embodiments of the invention provide a method and apparatus to facilitate directional proximity detection by a wireless device. In one embodiment of the invention, the wireless device has a phased array antenna system that facilitates the directional detection of other wireless device(s). For example, in one embodiment of the invention, the phased array antenna system of the wireless device uses a radiation pattern beam that circumrotates the wireless device to detect the proximity and location of other wireless devices.

In another example, in one embodiment of the invention, the wireless device uses a search strategy to optimize the process to detect the proximity and location of other wireless devices. The search strategy may adjust the radiation pattern beam to any desired angle to detect the proximity and location of other wireless devices in one embodiment of the invention. For example, in one embodiment of the invention, the wireless device uses a search strategy that first performs a wide angle, i.e., 360 or 180 degrees, of broadcasting to determine the broad location of the other wireless device(s). Secondly, once the wireless device has determined the broad location of the wireless device(s), the search strategy performs a narrow angle, i.e., 45 degrees of smaller, to determine the narrow and more accurate location of the other wireless device(s). By doing so, the wireless device is able to detect the other wireless device(s) within a small angle of detection and reduce the noise effects in one embodiment of the invention.

In one embodiment of the invention, the wireless device is capable of heterogeneous wireless communication by accessing a plurality of wireless networks and/or wired networks. In one embodiment of the invention, the wireless device includes, but is not limited to, a wireless electronic device such as a desktop computer, a laptop computer, a handheld computer, a tablet computer, a cellular telephone, a pager, an audio and/or video player (e.g., an MP3 player or a DVD player), a gaming device, a video camera, a digital camera, a navigation device (e.g., a GPS device), a wireless peripheral (e.g., a printer, a scanner, a headset, a keyboard, a mouse, etc.), a medical device (e.g., a heart rate monitor, a blood pressure monitor, etc.), digital audio speakers for enhanced audio, gaming devices, and/or other suitable fixed, portable, or mobile electronic devices.

The wireless device uses a modulation technique, including but not limited to, spread spectrum modulation (e.g., direct sequence code division multiple access (DS-CDMA) and/or frequency hopping code division multiple access (FH-CDMA)), time-division multiplexing (TDM) modulation, frequency-division multiplexing (FDM) modulation, orthogonal frequency-division multiplexing (OFDM) modulation, orthogonal frequency-division multiple access (OFDMA), multi-carrier modulation (MDM), and/or other suitable modulation techniques to communicate via wireless communication links.

In one embodiment of the invention, the wireless device communicates at least in part in accordance with communication standards such as, but are not limited to, Institute of Electrical and Electronic Engineers (IEEE) 802.11(a), 802.11(b), 802.11(g), 802.11(h), 802.11(j), 802.11(n), 802.16-2004, 802.16(e), 802.16(m) and their variations and evolutions thereof standards, and/or proposed specifications, Home Plug AV (HPAV), Ultra Wide Band (UWB), Bluetooth, or any form of wireless communication protocol, although the scope of the invention is not limited in this respect as they may also be suitable to transmit and/or receive communications in accordance with other techniques and standards.

For more information with respect to the IEEE 802.11 and IEEE 802.16 standards, please refer to “IEEE Standards for Information Technology—Telecommunications and Information Exchange between Systems”—Local Area Networks—Specific Requirements—Part 11 “Wireless LAN Medium Access Control (MAC) and Physical Layer (PHY), ISO/IEC 8802-11: 1999”, and Metropolitan Area Networks—Specific Requirements—Part 16: “Air Interface for Fixed Broadband Wireless Access Systems,” May 2005 and related amendments/versions.

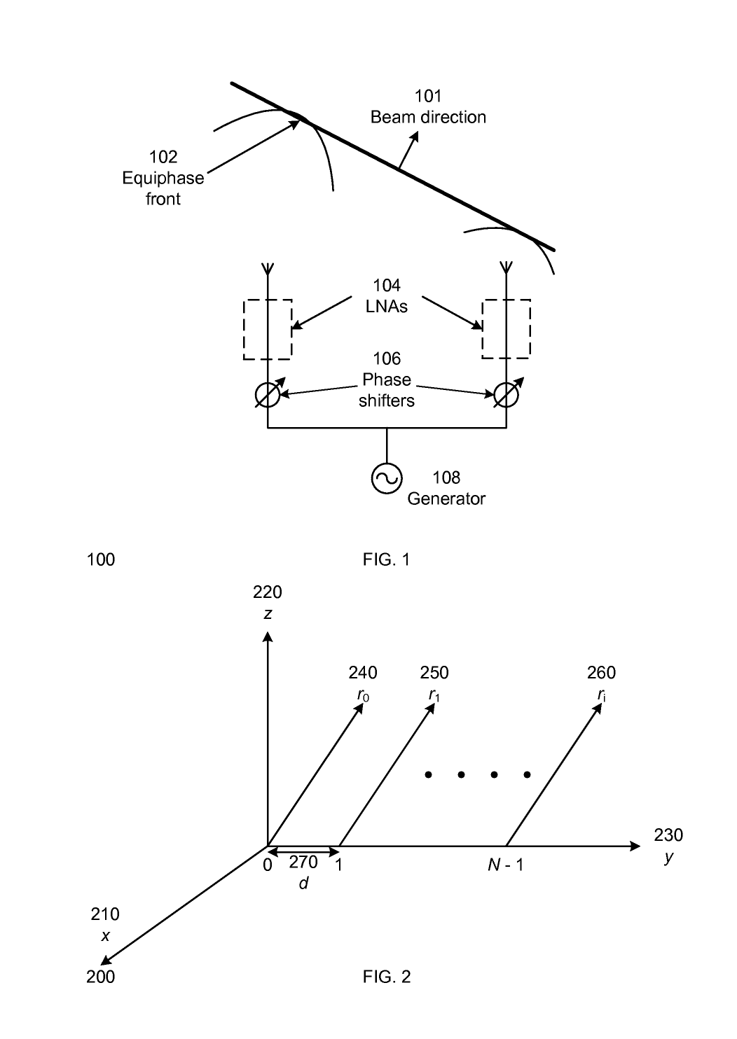

FIG. 1 illustrates an elementary or phase antenna array in a wireless device in accordance with one embodiment of the invention. In one embodiment of the invention, the elementary antenna array has two radiators or antennas fed by a common signal source or generator 106. The phase or delay shifters 106 provide the phase or delay control on each element of the elementary antenna array in one embodiment of the invention. The phase shifters 106 shift the feeding current phase into each antenna element to shift the transmitting signal's phase of the antenna elements in one embodiment of the invention. The phase shifters 106 can be developed using, but not limited to, Micro-Electro-Mechanical Systems (MEMS) switches and micro strip lines.

The elementary antenna array has a set of two or more antennas radiating or receiving electromagnetic energy with a known and controllable relationship between the time phases of the energy in each element in one embodiment of the invention. The radiation beams from the two radiators add vectorially in space as illustrated by the equiphase front 104 and the beam direction 102. The direction of the maximum beam is controlled by the phase shifter 106 on each element in one embodiment of the invention.

In one embodiment of the invention, the shape of the beam of the antenna array is dependent on, but not limited to, the number and spacing of the elements of the antenna array, the relative amplitude of the feeding lines, and the phase of the feeding lines. The strength of the received signal can be increased by adding the low noise amplifiers (LNAs) 104 ahead of each antenna or radiator. The LNAs 104 amplifies the transmitted signals and is placed as close as possible to the radiating elements so that very little signal loss occurs before the first amplification on receiving the transmitted signals in one embodiment of the invention.

The wireless device has logic that controls the phased antenna array and it directs the phased antenna array to adjust the radiation pattern and search method so as to better facilitate the effective location of neighboring devices. The logic is part of the software that executes in the wireless device in one embodiment of the invention. In another embodiment of the invention, the logic is part of a firmware that executes in the wireless device. In yet another embodiment of the invention, the logic is part of an angle data signal processor that has software running as part of the proximity detection service which manages and controls the phase control signal, calculates the receiving Received Signal Strength Indication (RSSI) or Received Channel Power Indicator (RCPI) per beam and estimates the corresponding direction angle information.

In one embodiment of the invention, the wireless device receives the wireless signals transmitting from the neighboring wireless devices. The wireless device scans its surrounding region by circumrotating the direction of the beam or by using a search strategy in one embodiment of the invention. To change the direction of the beam, the elementary antenna array changes the time delay or phase of the signals on each element in one embodiment of the invention.

The wireless device receives the packets from the other wireless devices and measures or determines the RCPI/RSSI at each step or point of the scanning. For example, in one embodiment of the invention, the wireless device performs the scanning of its surrounding region by rotating the beam four times at 45 degrees. This allows a 360 degrees scanning by the wireless device. At each quadrant of the scanning, the wireless device measures the RSSI of the received packets in one embodiment of the invention. To determine the respective direction of a neighboring device, the wireless device determines the highest or best RSSI measurement among the RSSI measurements for each quadrant. The quadrant that gives the best or highest RSSI measurement indicates the direction of the neighboring wireless device in one embodiment of the invention.

The wireless device may also set a RSSI threshold that indicates the proximity of the neighboring devices from the wireless device. For example, in one embodiment of the invention, the wireless device wants to determine the neighboring wireless devices that are within a particular distance. In one embodiment of the invention, the wireless device configures the RSSI threshold that indicates a particular distance by performing an initial RSSI measurement of the received packets from another wireless device that is placed at the particular distance away from the wireless device.

For example, in one embodiment of the invention, the wireless device is required to detect the neighboring wireless devices that are within 1 meter of the wireless device. The wireless device performs a calibration step of measuring the RSSI of the received packets from another wireless device that is placed 1 meter away from the wireless device. In one embodiment of the invention, the wireless device uses the measured RSSI of the received packets from the other wireless device that is placed 1 meter away from the wireless device as the RSSI threshold. By doing so, the wireless device is able to detect the neighboring wireless devices that are within the desired distance and is able to detect the direction of the neighboring wireless devices with respect to the wireless device in one embodiment of the invention.

The above illustrations of determining the proximity and the direction of the neighboring wireless devices are not meant to be limiting. One of ordinary skill in the relevant art will readily appreciate that the angular width of the beam of the wireless device can be set to another angle and it shall not be described herein. One of ordinary skill in the relevant art will also readily appreciate that other criteria besides the RSSI of the received packets can be used without affecting the workings of the invention and the description of the other criteria shall not be described herein. For example, in one embodiment of the invention, the RCPI of the received packets is used as the criteria. The ability of a wireless device to detect the location and proximity of another wireless device enables collaboration between users in one embodiment of the invention.

FIG. 2 illustrates a linear phase antenna array 200 in accordance with one embodiment of the invention. The linear phase antenna array 200 is a distribution of antenna elements that utilize the element spacing, or location, along with a variable phase control or phase shifter at each element which will allow the effective radiation pattern of the array to rotate to a desired direction in one embodiment of the invention.

The x axis 210, y axis 230 and the z axis 220 illustrate the three axes and the linear phase antenna array 200 is illustrated as N number of elements that lie in the y-z plane. The linear phase antenna array 200 has the elements r₀ 240, r₁ 250 and rᵢ 260. The element rᵢ 260 represents that the linear phase antenna array 200 can have any number of elements in one embodiment of the invention.

By allowing the receiving beams of the linear phase antenna array 200 to be rotated, it allows the wireless device to detect the direction of the other neighboring wireless devices in one embodiment of the invention. The beam width of the linear phase antenna array 200 determines the accuracy of the direction detection. By designing the antenna array in a corresponding manner and electronically controlling the phase shifter, the width of the beam can be designed to be 45 degrees or lower in one embodiment of the invention.

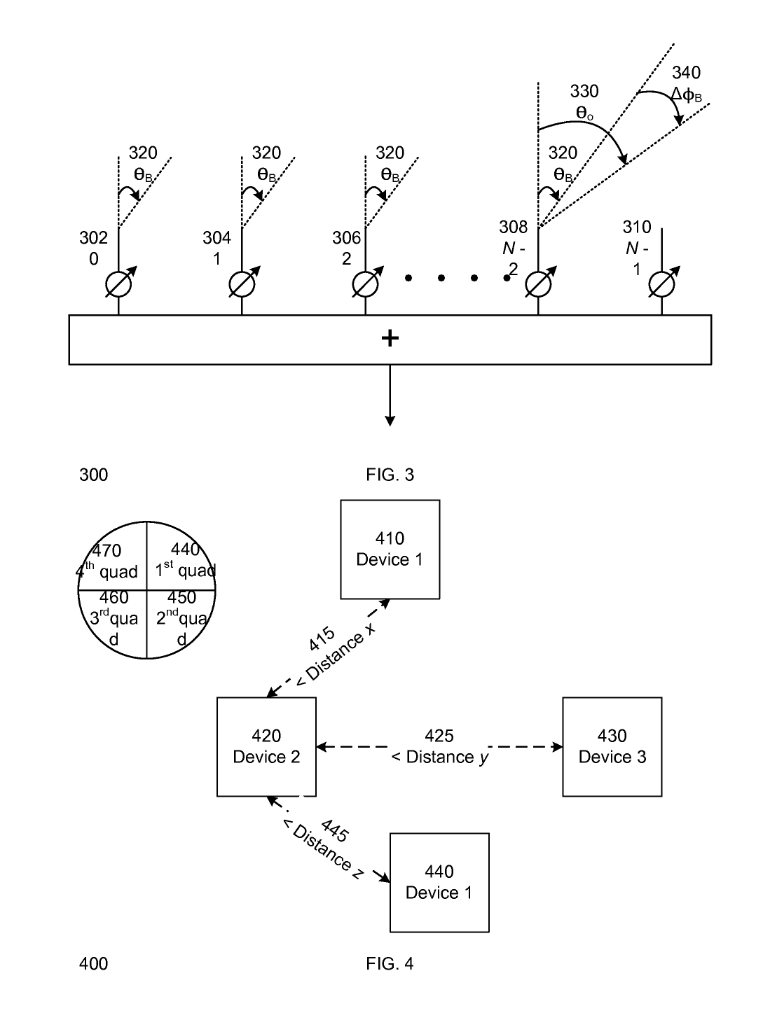

FIG. 3 illustrates the direction of the beam of the linear phase antenna array 300 in accordance with one embodiment of the invention. For clarity of illustration, FIG. 3 is discussed with reference to FIG. 2. The linear phase antenna array 300 has N antenna elements that has a phase shifter 0 302, 1 304, 2 306, (N-2) 308 and (N-1) 310 in one embodiment of the invention. The number N represents that there can be any number of antenna elements and phase shifters.

Each of the N antenna elements in the linear phase antenna array 300 is illustrated to have a radiation beam at an angle _{B} 320. The direction of the object, i.e., the other wireless device, is illustrated to have an angle ₒ 330. The difference between the angle of the radiation beam and the angle of the object is illustrated as Δ_{B} 340. In one embodiment of the invention, when the design of each antenna element and their distance is fixed, the beam direction of the linear antenna array radiation pattern can be changed accordingly by tuning the feeding current phase.

For example, in one embodiment of the invention, the beam direction of the linear antenna array radiation pattern is changed to the direction of the object by feeding the current phase of Δ_{B} 340 to each of the phase shifter 0 302, 1 304, 2 306, (N-2) 308 and (N-1) 310. The illustration in FIG. 3 shows a linear phase antenna array for clarity of illustration and it is not meant to be limiting. For other arrays that are placed in a non-linear way, the radiation pattern of the phase antenna array can be considered as a multiplication of the multiple linear arrays' radiation pattern. One of ordinary skill in the relevant art will readily appreciate how to configure the phase shifters for other non-linear antenna arrays and shall not be described herein.

FIG. 4 illustrates a usage scenario in accordance with one embodiment of the invention. The wireless devices 1 410, 2 420 3 430 and 4 440 illustrates a usage scenario in one embodiment of the invention. The device 1 410 is assumed to be located at distance x 415 away from the device 2 420, the device 3 430 is assumed to be located at distance y 425 away from the device 2 420, and the device 4 440 is assumed to be located at distance z 445 away from the device 2 420.

In one embodiment of the invention, each of the wireless devices 1 410, 2 420 3 430 and 4 440 has a hardware based phase control structure. The hardware based phase control structure changes its status based on a control signal. The control signal periodically changes as a function of time in one embodiment of the invention. When the hardware based phase control structure changes its status, the antenna array's receiving radiation pattern beam changes its direction.

When a beam's direction covers the direction where the other device is facing the detecting device, the receiving power achieves the maximum value in the particular detecting period. This allows any one of the wireless devices 1 410, 2 420 3 430 and 4 440 to determine from the beam's direction about the respective direction of the neighboring device.

For clarity of illustration, the 1^{st} quadrant 440, 2^{nd} quadrant 450, 3^{rd} quadrant 460 and 4th quadrant 470 illustrate the four possible regions of rotating the beam direction in one embodiment of the invention. For example, in one embodiment of the invention, the wireless device 2 420 performs a directional proximity detection of its neighboring wireless devices 1 410, 3 430 and 4 440 by checking which one of the 1^{st} quadrant 440, 2^{nd} quadrant 450, 3^{rd} quadrant 460 and 4th quadrant 470 has the highest RSSI measurements for the received packets from the wireless devices 1 410, 3 430 and 4 440.

Since the wireless device 1 410 is illustrated to lie in the region of the 1^{st} quadrant 440 of the wireless device 2 420 and assuming that the distance x 415 is within the proximity desired by the wireless device 2 420, the measurement of the RSSI of the received packets from the wireless 1 410 is the highest when the beam of the wireless device 2 420 is rotated to the 1^{st} quadrant 440. This allows the wireless device 2 420 to determine that the direction of the wireless device 2 420 is in the 1^{st} quadrant.

Assuming the distance y 425 is beyond the proximity desired by the wireless device 2 420, the wireless device 2 420 does not detect the direction of the wireless device 3 430. Since the wireless device 4 440 is illustrated to lie in the region of the 2^{nd} quadrant 450 of the wireless device 2 420 and assuming that the distance z 445 is within the proximity desired by the wireless device 2 420, the measurement of the RSSI of the received packets from the wireless 4 440 is the highest when the beam of the wireless device 2 420 is rotated to the 2^{nd} quadrant 450. This allows the wireless device 2 420 to determine that the direction of the wireless device 4 440 is in the 2^{nd} quadrant.

In one embodiment of the invention, the setting of the RSSI threshold for the desired proximity is set during a calibration procedure where the RSSI measurement of the received packets from a wireless device is measured when the wireless device is set to a known device or desired distance. The phase control of the phase shifters is controlled electronically in one embodiment of the invention. This allows a faster response time in changing the position of the antenna beam.

The usage scenario illustrated in FIG. 4 is not meant to be limiting. For clarity of illustration, the wireless devices 1 410, 2 420 3 430 and 4 440 are assumed to be lying in substantially the same plane of each other. In other usage scenarios where wireless devices 1 410, 2 420 3 430 and 4 440 are not lying in substantially the same plane of each other, the addition of a gyroscope aids in assisting the user to position the wireless devices in the appropriate plane for the directional proximity detection.

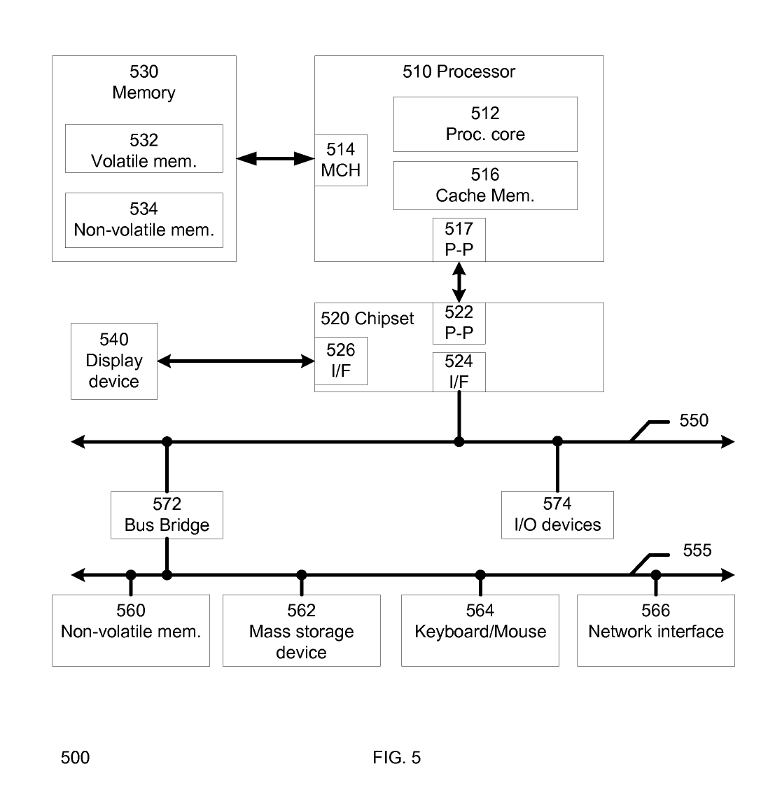

FIG. 5 illustrates a system 500 to implement the methods disclosed herein in accordance with one embodiment of the invention. The system 500 illustrates a wireless device in one embodiment of the invention. The system 500 includes, but is not limited to, a desktop computer, a laptop computer, a net book, a notebook computer, a personal digital assistant (PDA), a server, a workstation, a cellular telephone, a mobile computing device, an Internet appliance or any other type of computing device. In another embodiment, the system 500 used to implement the methods disclosed herein may be a system on a chip (SOC) system.

The processor 510 has a processing core 512 to execute instructions of the system 500. The processing core 512 includes, but is not limited to, pre-fetch logic to fetch instructions, decode logic to decode the instructions, execution logic to execute instructions and the like. The processor 510 has a cache memory 516 to cache instructions and/or data of the system 500. In another embodiment of the invention, the cache memory 516 includes, but is not limited to, level one, level two and level three, cache memory or any other configuration of the cache memory within the processor 510.

The memory control hub (MCH) 514 performs functions that enable the processor 510 to access and communicate with a memory 530 that includes a volatile memory 532 and/or a non-volatile memory 534. The volatile memory 532 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 534 includes, but is not limited to, NAND flash memory, phase change memory (PCM), read only memory (ROM), electrically erasable programmable read only memory (EEPROM), or any other type of non-volatile memory device.

The memory 530 stores information and instructions to be executed by the processor 510. The memory 530 may also stores temporary variables or other intermediate information while the processor 510 is executing instructions. The chipset 520 connects with the processor 510 via Point-to-Point (PtP) interfaces 517 and 522. The chipset 520 enables the processor 510 to connect to other modules in the system 500. In one embodiment of the invention, the interfaces 517 and 522 operate in accordance with a PtP communication protocol such as the Intel® QuickPath Interconnect (QPI) or the like. The chipset 520 connects to a display device 540 that includes, but is not limited to, liquid crystal display (LCD), cathode ray tube (CRT) display, or any other form of visual display device.

In addition, the chipset 520 connects to one or more buses 550 and 555 that interconnect the various modules 574, 560, 562, 564, and 566. Buses 550 and 555 may be interconnected together via a bus bridge 572 if there is a mismatch in bus speed or communication protocol. The chipset 520 couples with, but is not limited to, a non-volatile memory 560, a mass storage device(s) 562, a keyboard/mouse 564 and a network interface 566. The mass storage device 562 includes, but is not limited to, a solid state drive, a hard disk drive, an universal serial bus flash memory drive, or any other form of computer data storage medium. The network interface 566 is implemented using any type of well known network interface standard including, but not limited to, an Ethernet interface, a universal serial bus (USB) interface, a Peripheral Component Interconnect (PCI) Express interface, a wireless interface and/or any other suitable type of interface. The wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 5 are depicted as separate blocks within the system 500, the functions performed by some of these blocks may be integrated within a single semiconductor circuit or may be implemented using two or more separate integrated circuits. For example, although the cache memory 516 is depicted as a separate block within the processor 510, the cache memory 516 can be incorporated into the processor core 512 respectively. The system 500 may include more than one processor/processing core in another embodiment of the invention.

The methods disclosed herein can be implemented in hardware, software, firmware, or any other combination thereof. Although examples of the embodiments of the disclosed subject matter are described, one of ordinary skill in the relevant art will readily appreciate that many other methods of implementing the disclosed subject matter may alternatively be used. In the preceding description, various aspects of the disclosed subject matter have been described. For purposes of explanation, specific numbers, systems and configurations were set forth in order to provide a thorough understanding of the subject matter. However, it is apparent to one skilled in the relevant art having the benefit of this disclosure that the subject matter may be practiced without the specific details. In other instances, well-known features, components, or modules were omitted, simplified, combined, or split in order not to obscure the disclosed subject matter.

The term “is operable” used herein means that the device, system, protocol etc, is able to operate or is adapted to operate for its desired functionality when the device or system is in off-powered state. Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

The techniques shown in the figures can be implemented using code and data stored and executed on one or more computing devices such as general purpose computers or computing devices. Such computing devices store and communicate (internally and with other computing devices over a network) code and data using machine-readable media, such as machine readable storage media (e.g., magnetic disks; optical disks; random access memory; read only memory; flash memory devices; phase-change memory) and machine readable communication media (e.g., electrical, optical, acoustical or other form of propagated signals—such as carrier waves, infrared signals, digital signals, etc.).

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. An apparatus comprising:
a plurality of antennas;
a plurality of phase shifters, wherein each phase shifter is coupled with a respective one of the plurality of antennas; and
logic to:
configure the plurality of phase shifters to rotate a respective receiving beam of each antenna; and
determine a direction of a wireless device based on the rotation of the respective receiving beam of each antenna.

2. The apparatus of claim 1, wherein each phase shifter is to shift a respective feeding current phase into each antenna.

3. The apparatus of claim 1, further comprising:
a plurality of Low Noise Amplifiers (LNAs), wherein each LNA is coupled with a respective one of the plurality of antennas.

4. The apparatus of claim 2, wherein the logic to configure the plurality of phase shifters to rotate the respective receiving beam of each antenna is to:
configure each phase shifter to shift the respective feeding current phase into each antenna to rotate the respective receiving beam of each antenna.

5. The apparatus of claim 1, wherein the logic to determine the direction of the wireless device based on the rotation of the respective receiving beam of each antenna is to:
determine a Received Signal Strength Indication (RSSI) of received packets from the wireless device for the respective receiving beam of each antenna;
estimate the direction of the wireless device based on the determined RSSI of the received packets from the wireless device for the respective receiving beam of each antenna.

6. The apparatus of claim 1, wherein the logic to determine the direction of the wireless device based on the rotation of the respective receiving beam of each antenna is to:
determine a Received Channel Power Indicator (RCPI) of received packets from the wireless device for the respective receiving beam of each antenna;
estimate the direction of the wireless device based on the determined RCPI of the received packets from the wireless device for the respective receiving beam of each antenna.

7. The apparatus of claim 1, further comprising a gyroscope, and wherein the logic to determine the direction of the wireless device based on the rotation of the respective receiving beam of each antenna is to determine the direction of the wireless device based on the rotation of the respective receiving beam of each antenna and the gyroscope.

8. The apparatus of claim 1, wherein the apparatus is operable at least in part with one of Institute of Electrical and Electronics Engineers (IEEE) 802.11 standard, a IEEE 802.16m standard, a 3rd Generation Partnership Project (3GPP) Long Term Evolution standard, a Bluetooth standard, a ultra wideband standard.

9. An apparatus comprising:
an antenna array having a plurality of antenna elements;
a plurality of phase shifters, wherein each phase shifter is coupled with a respective one of the plurality of antenna elements; and
logic to vary an effective radiation pattern of the antenna array to determine a spatial location of a wireless device communicatively coupled with the apparatus.

10. The apparatus of claim 9, wherein the logic to vary the effective radiation pattern of the antenna array is to vary the effective radiation pattern of the antenna array based on a spacing of the plurality of antenna elements and the plurality of phase shifters.

11. The apparatus of claim 9, wherein the logic to vary the effective radiation pattern of the antenna array to determine the spatial location of the wireless device communicatively coupled with the apparatus is to:
rotate a respective receiving beam of each antenna element around the wireless device;
determine a Received Signal Strength Indication (RSSI) of received packets from the wireless device for the respective receiving beam of each antenna element; and
estimate the spatial location of the wireless device based on the determined RSSI of the received packets from the wireless device for the respective receiving beam of each antenna element.

12. The apparatus of claim 9, wherein the logic to vary the effective radiation pattern of the antenna array to determine the spatial location of the wireless device communicatively coupled with the apparatus is to:
rotate a respective receiving beam of each antenna element around the wireless device;
determine a Received Channel Power Indicator (RCPI) of received packets from the wireless device for the respective receiving beam of each antenna element; and
estimate the spatial location of the wireless device based on the determined RCPI of the received packets from the wireless device for the respective receiving beam of each antenna element.

13. The apparatus of claim 9, wherein the logic to rotate the respective receiving beam of each antenna element around the wireless device is to shift a respective feeding current phase by a respective phase shifter into each antenna element.

14. The apparatus of claim 9, further comprising:
a plurality of Low Noise Amplifiers (LNAs), wherein each LNA is coupled with a respective one of the plurality of antenna elements.

15. The apparatus of claim 9, further comprising a gyroscope, and wherein the logic to vary the effective radiation pattern of the antenna array to determine the spatial location of the wireless device communicatively coupled with the apparatus is to vary the effective radiation pattern of the antenna array to determine the spatial location of the wireless device communicatively coupled with the apparatus based at least in part on the gyroscope.

16. The apparatus of claim 9, wherein the apparatus is operable at least in part with one of Institute of Electrical and Electronics Engineers (IEEE) 802.11 standard, a IEEE 802.16m standard, a 3rd Generation Partnership Project (3GPP) Long Term Evolution standard, a Bluetooth standard, a ultra wideband standard.

17. A method comprising:
determining a directional proximity of a first wireless device from a second wireless device by circumrotating a beam of an antenna array of the first wireless device, wherein the circumrotation of the beam of the antenna array is performed using a step not more than forty five degrees.

18. The method of claim 17, wherein circumrotating the beam of the antenna array of the first wireless device comprises: shift, by the first wireless device, a respective feeding current phase by a respective phase shifter into each antenna element of the antenna array.

19. The method of claim 17, wherein determining the directional proximity of the first wireless device from the second wireless device by circumrotating the beam of the antenna array of the first wireless device comprises:
determining, by the first wireless device at each step of circumrotating the beam of the antenna array, a Received Signal Strength Indication (RSSI) of received packets from the second wireless device for the beam of the antenna array in the first wireless device; and
determining the directional proximity of the first wireless device from the second wireless device based on the determined RSSI of the received packets from the second wireless device.

20. The method of claim 17, wherein determining the directional proximity of the first wireless device from the second wireless device by circumrotating the beam of the antenna array of the first wireless device comprises:
determining, by the first wireless device at each step of circumrotating the beam of the antenna array, a Received Channel Power Indicator (RCPI) of received packets from the second wireless device for the beam of the antenna array in the first wireless device; and
determining the directional proximity of the first wireless device from the second wireless device based on the determined RCPI of the received packets from the second wireless device.

21. The method of claim 19, wherein determining the directional proximity of the first wireless device from the second wireless device based on the determined RSSI of the received packets from the second wireless device comprises:
determining an orientation of the first wireless device; and
determining the directional proximity of the first wireless device from the second wireless device based on the determined RSSI of the received packets from the second wireless device and the determined orientation of the first wireless device.

22. The method of claim 17, wherein the first and the second wireless devices are operable at least in part with one of Institute of Electrical and Electronics Engineers (IEEE) 802.11 standard, a IEEE 802.16m standard, a 3rd Generation Partnership Project (3GPP) Long Term Evolution standard, a Bluetooth standard, a ultra wideband standard.
